(19) United States
(12) Patent Application Publication
(10) Pub. No.: US 2021/0140575 A1
(43) Pub. Date: May 13, 2021

(54) TOOLLESS SADDLE

(71) Applicant: A. Y. McDonald Mfg. Co., Dubuque, IA (US)

(72) Inventors: Tyler Peterson, Dubuque, IA (US); Don Stark, London (CA); Steve Greulich, Cambridge (CA)

(21) Appl. No.: 16/681,312

(22) Filed: Nov. 12, 2019

(51) Int. Cl. F16L 41/12; F16L 55/17

(52) U.S. Cl. CPC F16L 41/12; F16L 55/1715

(57) ABSTRACT

A saddle for a pipe, including a band adapted to wrap around a portion of the pipe to selectively block a leak or connect a service line. A securement device includes a handle pivotably connected to one of the band opposite sides, a puller pivotably connected to the other of the band opposite sides, and a pivotable connection between the handle and the puller. The pivotable connection pulls the band opposite sides toward one another when the handle is pivoted against the band.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates generally to service saddles and repair clamps of the type used to establish lateral connections to a pipe and/or to repair and seal fluid leaks in pipes.

### BACKGROUND OF THE INVENTION

Saddles are used to establish lateral connections to large diameter pipes such as may be found in municipal water systems, water irrigations systems, and private water systems. In municipal water systems, for example, residential connections are made by tapping into a large diameter water main to connect to a smaller diameter service line running to the residence.

Typically, saddles are made from castings which include two arcuate section, one having a valve boss integrally formed therewith for making a connection to a service line. The arcuate sections are rigid and have an inside diameter substantially equal to the outside diameter of the pipe to be tapped. The arcuate sections are fastened together around the pipe by means of any combination of nuts, bolts, or hinge mechanisms.

Saddles have also been formed and welded from sheet metal, comprising one or more pieces with welded bolt plates at either end of such a saddle piece allowing the circle of the saddle to be closed around the pipe and tensioned to compress a sealing gasket.

Repair clamps have also been made in similar manner with stainless steel sheet metal, with bolt plates mounted at either end, causing the clamp to be closed around the pipe to compress a complete circumferential gasket.

Such saddles and repair clamps have generally been mounted and tensioned using bolts and a tool capable of applying torque to those bolts. For proper installation they generally require the torqueing tool to be capable of measuring or limiting that torque.

Further, materials used to make pipes are subject to various degrees of thermal expansion and contraction which can cause the pipe to increase in diameter after a saddle is installed and properly tensioned. Such increase in diameter can cause undue stress in saddle or pipe materials and may lead to failure of the saddle or pipe.

It is an object of this invention to provide saddles and repair clamps that overcomes the shortcomings of the prior art.

### SUMMARY OF THE INVENTION

In one aspect, a saddle for a main pipe having an outer circumference adapted to selectively block a leak through the main pipe or connect a service pipe to the main pipe is provided. The saddle includes a band adapted to wrap around a portion of the main pipe to selectively block a leak in the main pipe portion or connect a service pipe to the main pipe portion. A securement device includes a handle pivotably connected to one of the band opposite sides, a puller pivotably connected to the other of the band opposite sides, and a pivotable connection between the handle and the puller. The puller pivots relative to the handle and pulls the band opposite sides toward one another when the handle is pivoted against the band.

In one form of this aspect, the main pipe has a central axis, and the handle pivots about the one band opposite side around a first axis parallel to the central axis, the puller pivots about the other band opposite side around a second axis parallel to the central axis, and the pivotable connection between the handle and the puller is pivotable about an axis parallel to said central axis. In a further form, the other band opposite side includes a plurality of hooks defining a plurality of second axes wherein the puller is selectively pivoted at a selected one of the plurality of second axes.

In another form of this aspect, at least one pin is slidably connected to the one band opposite side whereby the pin is selectively slidable to trap the handle in a locked position between the pin and the band. In an alternative form, a spring tab is on the one band opposite side whereby the spring tab is selectively biased toward a locked position over a portion of the handle when the handle is pivoted against the band.

In still another form of this aspect, a compression spring is between the other of the band opposite sides and the pivotable connection.

In yet another form of this aspect, the band includes an integral boss adapted to define a connection to a service line extending laterally from the main pipe.

In another form of this aspect, a gasket on the main pipe side of the band prevents leaking of the main pipe where surrounded by the band.

In still another form of this aspect, a plurality of the securement devices are spaced axially on the band.

In another form of this aspect, the first and second axes define a plane, and the band is secured to the main pipe with the pivotable connection between the plane and the main pipe.

In still another form of this aspect, the band opposite sides are pulled toward one another by the puller to tension the band around the main pipe.

In yet another form, the band has an axial dimension and a lateral dimension between opposite sides wrapped around the main pipe portion and the band lateral dimension is less than the main pipe circumference.

In another aspect, a saddle for a main pipe having an outer circumference adapted to selectively block a leak through the main pipe or connect a service pipe to the main pipe is provided. The saddle includes a band adapted to wrap around a portion of the main pipe to selectively block a leak in the main pipe portion or connect a service pipe to the main pipe portion. A first puller is connected to one of the band opposite sides, a second puller is connected to the other of the band opposite sides, and a handle has two links and an intermediate pivotal connection between the links. The handle is pivotally connected on one end to the first puller and pivotally connected on the other end to the second puller, whereby pivoting the handle links into a substantially straight alignment pulls the band opposite sides together.

In one form of this aspect, the band opposite sides are pulled toward one another by the first and second pullers to tension the band around the main pipe.

In another form of this aspect, the band has an axial dimension and a lateral dimension between opposite sides wrapped around the main pipe portion and the band lateral dimension is less than the main pipe circumference.

In still another aspect, a saddle for a main pipe having an outer circumference adapted to selectively block a leak through the main pipe or connect a service pipe to the main pipe is provided. The saddle includes a band adapted to wrap around a portion of the main pipe to selectively block a leak in the main pipe portion or connect a service pipe to the main pipe portion. A securement device includes a handle pivotably connected to one of the band opposite sides, a puller pivotably connected to the other of the band opposite sides and extending over the one band opposite side, and a link pivotably connected on one end to the puller and on the other end to the handle. Pivoting the handle toward the band increases the distance between the handle connection to the one band opposite side and the link connection to the puller

In one form of this aspect, the band opposite sides are pulled toward one another by the securement device to tension the band around the main pipe.

Other objects, features, and advantages of the invention will become apparent from a review of the entire specification, including the appended claims and drawings.

### BRIEF DESCRIPTION OF THE DRAWINGS

FIG. 1 is a perspective view of a tension buckle saddle in its closed position;

FIG. 2 is a side view of the tension buckle saddle in its closed position;

FIG. 3 is a perspective view of the tension buckle saddle in its open position;

FIG. 4 is a side view of the tension buckle saddle in its open position;

FIG. 5 is a perspective view of a spring loaded tension buckle saddle in its closed position;

FIG. 6 is a side view of the spring loaded tension buckle saddle in its open position;

FIG. 7 is a perspective view of an auto-adjusting saddle in its open position;

FIG. 8 is a perspective exploded side view of the auto-adjusting saddle in its open position;

FIG. 9 is a perspective view of the auto-adjusting saddle in its closed position;

FIG. 10 is an expanded side view of the securement device of the auto-adjusting saddle in its closed position;

FIG. 11 is an expanded side view of the securement device of the auto-adjusting saddle in its open position;

FIG. 12 is a perspective view of a compression buckle saddle in a partially open position;

FIG. 13 is a transverse sectioned side view of the compression buckle saddle in its open position;

FIG. 14 is a transverse sectioned side view of the compression buckle saddle in its partially open position;

FIG. 15 is a transverse sectioned side view of the compression buckle saddle in its closed position;

FIG. 16 is a perspective view of a hinged saddle in its open position;

FIG. 17 is a side view of the hinged saddle in its open position;

FIG. 18 is a perspective view of a boss saddle in its closed position;

FIG. 19 is an exploded perspective view of the boss saddle;

FIG. 20 is a side view of the boss saddle in its closed position;

FIG. 21 is a perspective view of a tension buckle repair clamp in its partially open position;

FIG. 22 is a side view of the tension buckle repair clamp in its partially open position;

FIG. 23 is a perspective view of an alternative tension buckle saddle in its open position;

FIG. 24 is a side view of the alternative tension buckle saddle in its open position;

FIG. 25 is a perspective view of the alternative tension buckle saddle in its closed position;

FIG. 26 is a side view of the alternative tension buckle saddle in its closed position; and

FIG. 27 is a cross-sectional view of the alternative tension buckle saddle showing locking in the closed position.

### DETAILED DESCRIPTION

FIGS. 1-4 illustrate an advantageous saddle 25 for blocking leaks from a main pipe 30 and/or providing a boss 32 for connecting a service pipe to a main pipe 30. The main pipe 30 may be virtually any oval pipe, tube or conduit, and may have a variety of surfaces.

As illustrated throughout, the saddle 25 includes a band 36 which is flexible and may have a lateral dimension less than the outer circumference of the main pipe 30 (i.e., when wrapped around the main pipe 30, the band 36 does not go all the way around the main pipe 30 and thus the opposite sides 38, 39 of the band 36 are spaced apart). However, it should be appreciated that in this and the other structures illustrated herein, the band 36 could have a lateral dimension which is greater than the circumference of the main pipe 30, in which case tightening of the band 36 could result in some overlap of the opposite sides 38, 39 of the band 36. In that case, it should also be appreciated that while tightening of an overlapping band could technically to be said to involve moving the band edges apart (i.e., as the overlap is increased), references herein to the band sides being pulled toward each other are intended to refer to increasing of the overlap.

The boss 32 is integral with the band 12, with the boss 32 aligned with a hole in the main pipe 30 and adapted to conveniently connect with a service pipe.

A securement device 40 is provided to secure the band 36 around the main pipe 30 with sufficient tension that the band 36 tightly squeezes around the main pipe 30 to ensure no leakage between the band 36 and the main pipe 30. A gasket may also be provided between the main pipe 30 and band 36 to facilitate such a connection (see, e.g., FIGS. 21-22 which include the gasket in the illustrations). Alternatively, or additionally, an O-ring gasket 42 (such as shown in the structures of FIGS. 19-20) may be provided around the boss 32 to prevent leaking around the service pipe opening.

Specifically, the securement device 40 includes a handle 50 with a pivot connection 52 to one side 38 of the band 36. A puller 60 is pivotally secured on one end to the other side 39 of the band 36 and on the other end the puller 60 has a pivot connection 62 to the handle 50. The pivotal connections are pivotable about axes which are substantially parallel to the main pipe center axis 66.

Advantageously, a plurality of selective pivotal connections between the puller 60 and the band side 39 are provided by hooks 70a, 70b extending axially and adapted to pivotally secure axial wings 72 on that end of the puller 60 whereby the saddle 25 may be adapted for use with different diameter main pipes 30. Any number of hooks may be used to facilitate proper tensioning and compression on pipes with a range of diameters.

As illustrated when comparing FIGS. 1-2 and FIGS. 3-4, it should be appreciated that when the handle 50 is pivoted down against the band 36, it will pull the puller 60 and connected band side 39 toward the other band side 38, thereby tightening the band 36 around the main pipe 30. Moreover, the securement device 40 has an over-center operation such that when the handle 50 is pivoted against the band side 38, the tensile force will secure the handle 50 in place (when the axis of the pivot connection 62 between the handle 50 and puller 60 is between the main pipe 30 and the plane 74 {see FIG. 2] defined by the pivot axes of pivot connection 52 and the axial wings 72. Axially slidable lock pins 76 may also be provided to trap the handle 50 in its securing position.

FIGS. 5-6 illustrate a variation of the saddle 25A of FIGS. 1-4 wherein the puller 60A of the securement device 40A is a spring 102 providing a substantial tension between the pivot connections 62 and 70 (i.e., 70a or 70b). The spring 102 attenuates changes in tension in the band 36 resulting from, for example, variation in pipe size caused by thermal fluctuations.

FIGS. 7-11 illustrate yet another advantageous saddle 25B and securement device 40B, wherein the puller 60B has a pivot connection 200 to one band side 38 and extends out to overlap the other band side 39. (Note that comparable elements of the different illustrated structures are identified by the same numbers with capital letters corresponding to each structure are used herein and shown in the Figures. Thus, the handle 50 is identified as 50A in FIGS. 5-2, 50B in FIGS. 7-11, and so forth to 50G used in FIGS. 23-27.)

The handle 50B is pivotally secured at 202 to the other band side 39. Further, a link 210 on one end has a pivot connection 214 to an intermediate point of the handle 50B and on the other end has a pivot connection 218 to the puller 60B. It should be appreciated by a comparison of FIGS. 10-11 that when the handle 50B is pivoted down, the link 210 will also pivot down (from the FIG. 11 position) to the FIG. 10 position in which the link 210 is substantially oriented around the band 36. In that position, the distance between the pivot connection 200 and pivot connection 214 is maximized to effectively pull the two band sides 38, 39 together.

Advantageously, the securement device 40B also includes a track assembly 240 which includes a track body 244, a wedge lock 248, and an activator wedge 252 which is held in place by a spring 256 mounted to the track body 244 to facilitate tightening. The track body 244 is pivotally connected (at 200) to one side 38 of the saddle band 36B, and the handle 50B is pivotally latched within the hooks (at 202) at the opposite side 39 of the band 36B. The handle 50B is also pivotally connected to the compression link 210 which is in turn pivotally linked with the wedge lock 248. The compression link 210 has a nose 260 which applies pressure to the upper side of the activator wedge 252 when the compression link 210 is in some orientations with reference to the activator wedge 252. When the compression link nose 260 ceases to apply pressure to the activator wedge 252, the spring 256 holds the activator wedge 252 in position such that the wedge lock 238 applies pressure through the separation plate 266 and into the activator wedge 252. When this takes place the wedges no longer move along the track body 244 and the handle 50B is forced to pivot about its connection with the compression link 210. This causes the pivot wise connection between the handle 50B and the band 36B to be forced upward, closing and tensioning the band 36B around the pipe 30 (not shown in FIGS. 7-11). Also, the wedge lock 248 and activator wedge 252 slide within the hollow interior of the track along the arc of reciprocation as the separation plate 266 slides vertically within a slot in the track. The wedge lock 248, separation plate 266 and activator wedge 252 work in cooperation to tension the saddle on pipes of various diameter automatically and without user-applied adjustments.

Yet another advantageous saddle configuration is illustrated in FIGS. 12-15 where (as in FIGS. 7-11 and 16-22 as well) the main pipe 30 is omitted to avoid clutter in the drawings but the illustrated saddle 25C is intended to be and is adapted to tightly secure the band 36C around a main pipe 30, whether to provide a convenient service line connection via the integral boss 32 and/or to block leakage from the main pipe 30.

In the FIGS. 12-15 structure, the securement device 40C includes rigid extensions or pullers 300, 304 secured to opposite sides 38, 39 of the band 36C. The pullers 300, 304 extend over the other band side 38, 39 and define pivot connections 310, 314 on their distal ends. One pivot connection 310 is to the handle 50C and the other pivotal connection 314 is to a compression link 316 to thereby form a buckle 318. The handle 50C may advantageously be a flat lever and two vertical arms, each with one closed attachment point for a pivotal connection on one end and an open attachment point or hook 320 for an additional pivotal connection at the other end.

When the saddle 25C is assembled, one of the rigid extensions or pullers 300 passes through the other rigid extension or puller 304, and the buckle 318 is drawn up narrowing the space between the pivot between extension 300 and compression link 316 and the further open attachment point or hook on the handle 50C. This allows the hook 320 to catch and pivot about the axial rod at the terminal end of rigid extension 304. The buckle 320 may then be brought back down by applying pressure to the handle 50C which presses the rigid extensions 300, 304 apart to close and tension the band 36C around the pipe 30.

FIGS. 16-17 illustrate another alternate advantageous embodiment of a saddle 25D which includes two arcuate sections 400, 402 connected together by a suitable hinge 406. One arcuate section 400 includes an integral boss 32 which may be positioned over an opening in the main pipe 30 for a lateral service line. A tension type over center buckle 410 similar to the securement device 40 of FIGS. 1-4 is provided to tightly secure the arcuate sections 400, 402 around a main pipe 30. Specifically, the buckle 410 includes a lever or handle 414 with a pivot connection 416 to one arcuate section 402 and a puller 420 which on one end has a pivot connection 422 to the other arcuate section 400. The other end of the puller 420 has a pivot connection 426 to the lever 414 near the center of the lever 414. It should thus be appreciated that pivoting of the lever 414 will pull the puller 420 to draw the two arcuate sections 400, 402 together for tightening around a main pipe 30. A spring lock 430 is also provided with a lip 432 which will snap over the end of the lever 414 when it is pivoted down to hold it in that position. It should be appreciated that the structure of FIGS. 16-17 could also be advantageously used with the band being a single continuous member rather than the hinged two arcuate sections 400, 402 as illustrated in the Figures.

FIGS. 18-20 illustrate another saddle 25E which, like the saddle 25D of FIGS. 16-17, may be advantageously used to secure a boss 32E onto a main pipe 30 to readily connected to a service line. In this configuration, a single band 36E is secured on opposite sides to a boss 32E which includes symmetrical hinge grooves 500, 502 on its opposite sides.

One side of the band 36E is secured to one side of the boss 32E by an “I” spanner 510, with the legs 514 on one side of the spanner 510 being pivotally secured to that side of the band 36E and the legs 516 on the other side of the spanner 510 nesting in the hinge groove 500 on that side of the boss 32E. A second “I” spanner 520 secures the other side of the boss 32E to the other side of the band 36E. That is, the legs 524 on one side of the spanner or puller 520 nest in the hinge groove 502 on that other side of the boss 32E, and the legs 526 on the other end of the spanner 520 have a pivot connection 530 to an over-center handle 50E. The over-center handle 50E also has a pivot connection 534 to that side of the band 36E with the alignment of the pivot connections 530, 534 and the nesting spanner legs 524 being such that tension in the saddle 25E will hold the handle 50E down in its secured position when assembled on a main pipe 30. It should be appreciated, however, that the boss 32E could be connected to the band 36E in any suitable manner in which the band 36E will secure the boss 32E against a main pipe 30, including, for example, as an integral part of the band 36E without use of the separate “I” spanners 510, 520 (see, e.g., the embodiment of FIGS. 16-17).

A suitable O-ring gasket 42 (such as discussed in connection with FIGS. 1-4) may be advantageously provided around the boss 32E to prevent leaking around the service pipe opening.

FIGS. 21-22 illustrate yet another configuration of a repair clamp 25F which is particularly suited for use in repairing a section of a main pipe 30 which has leaks. (As used herein, saddles 25 refer to structures which secure a boss 32 to a main pipe 30 for connecting a lateral service line, whereas repair clamps 25 refer to substantially the same structure but without a boss, where the band 36 which encloses the main pipe 30 block against leaking from the main pipe 30. It should be understood that the various embodiments disclosed herein could be used as either saddles [with a boss 32] or repair clamps [without a boss 32], or even as both [with a boss 32 but with the band 36 also covering areas of the main pipe 30 away from the boss 32 and service line to block leakage].)

In the FIGS. 21-22 repair clamp 25F, an axial length of a gasket 600 may be wrapped around a leaking section of a main pipe 30 with that gasket 600 secured tightly over leaking portions of the main pipe 30 by one or more securement devices 40F as needed to properly secure the band 36F around the gasket 600. In the illustrated FIGS. 21-22 embodiment, a single axially extending repair clamp 25F includes three securement devices 40F of a configuration such as illustrated in FIGS. 1-4. More or fewer securement devices 40F could be used depending on the pipe diameter and the axial length of the leaking pipe 30. Further it should be understood that one or more other securement devices could be used instead of, or together with, the securement devices 40F illustrated in FIGS. 21-22, including the securement device 40A of FIGS. 5-6, the securement devices 25B of FIGS. 7-11 and the securement devices 40C of FIGS. 12-15.

FIGS. 23-27 illustrate still another advantageous saddle 25G for blocking leaks from a main pipe 30 and/or providing a boss 32 for connecting a service pipe to a main pipe 30. The structure of FIGS. 23-27 is substantially similar to the structure illustrated in FIGS. 1-4, but with the puller 60G being in the form of a looped bail pivotally connected to the handle 50G and the handle lock 76G being in the form of a spring tab which flexes out of the way of the handle 50G as it is pivoted during installation until snapping back over a center portion 700 of the handle 50G where it blocks the handle 50G from pivoting back up (see particularly FIG. 27).

It should be appreciated that the various structures shown herein could be used as saddles (e.g., to attach a service line) or repair clamps (e.g., to cover leaks through a main pipe), or both. Thus, it should be appreciated that the configurations shown as saddles with a boss for a service line connection (as in FIGS. 1-20 and 23-27) could be used, with or without a boss, to block leaks. Similarly, the structure shown herein as a repair clamp (FIGS. 21-22) could include one or more bosses to connect a service line. For convenience of reference, saddles and repair clamps are collectively referred to herein as main pipe enclosures.

It should be appreciated that saddles as disclosed herein may be installed without the use of tools, and without requiring that the user be aware of bolt torque or band tension in order to properly install these devices. Further, it should be appreciated that saddles as disclosed herein may readily and reliably be installed on pipes of varying outside diameter. Further, it should be appreciated that saddles such as disclosed herein can readily accommodate variations of pipe diameter due to thermal effects without mechanical failure or leaks.

1. An enclosure for a main pipe having an outer circumference adapted to selectively connect a service pipe to said main pipe or block a leak through said main pipe, comprising:
a band adapted to wrap around a portion of said main pipe to selectively block a leak in said main pipe portion or connect a service pipe to said main pipe portion; and
a securement device including
a handle pivotably connected to one of said band opposite sides;
a puller pivotably connected to the other of said band opposite sides, and
a pivotable connection between said handle and said puller whereby said puller pivots relative to said handle and pulls said band opposite sides toward one another when said handle is pivoted against said band.

2. The main pipe enclosure of claim 1, further comprising at least one pin slidably connected to said one band opposite side whereby said pin is selectively slidable to trap said handle in a locked position between said pin and said band.

3. The main pipe enclosure of claim 1, further comprising a spring tab on said one band opposite side whereby said spring tab is selectively biased toward a locked position over a portion of said handle when said handle is pivoted against said band.

4. The main pipe enclosure of claim 1, further comprising a spring between said other of said band opposite sides and said pivotable connection.

5. The main pipe enclosure of claim 1, wherein said band includes an integral boss adapted to define a connection to a service line extending laterally from said main pipe.

6. The main pipe enclosure of claim 1, further comprising a gasket on the main pipe side of said band to prevent leaking of said main pipe where surrounded by said band.

7. The main pipe enclosure of claim 1, further comprising a plurality of said securement devices spaced axially on said band.

8. The main pipe enclosure of claim 1, wherein:
said main pipe has a central axis, and said handle pivots about said one band opposite side around a first axis parallel to said central axis,
said puller pivots about said other band opposite side around a second axis parallel to said central axis, and
said pivotable connection between said handle and said puller is pivotable about an axis parallel to said central axis.

9. The main pipe enclosure of claim 8, wherein said other band opposite side includes a plurality of hooks defining a plurality of second axes wherein said puller is selectively pivoted at a selected one of said plurality of second axes.

10. The main pipe enclosure of claim 1, wherein said first and second axes define a plane, and said band is secured to said main pipe with said pivotable connection between said plane and said main pipe.

11. The main pipe enclosure of claim 1, wherein said band opposite sides are pulled toward one another by said puller to tension said band around said main pipe.

12. The main pipe enclosure of claim 1, wherein said band has an axial dimension and a lateral dimension between opposite sides wrapped around said main pipe portion and said band lateral dimension is less than said main pipe circumference.

13. An enclosure for a main pipe having an outer circumference adapted to selectively block a leak through said main pipe or connect a service pipe to said main pipe, comprising:
a band adapted to wrap around a portion of said main pipe to selectively block a leak in said main pipe portion or connect a service pipe to said main pipe portion;
a first puller connected to one of said band opposite sides;
a second puller connected to the other of said band opposite sides; and
a handle having two links and an intermediate pivotal connection between the links, said handle being pivotally connected on one end to said first puller and pivotally connected on the other end to said second puller, whereby pivoting said handle links into a substantially straight alignment pulls said band opposite sides together.

14. The main pipe enclosure of claim 13, wherein said band opposite sides are pulled toward one another by said first and second pullers to tension said band around said main pipe.

15. The main pipe enclosure of claim 13, wherein said band has an axial dimension and a lateral dimension between opposite sides wrapped around said main pipe portion and said band lateral dimension is less than said main pipe circumference.

16. A main pipe enclosure for a main pipe having an outer circumference adapted to selectively block a leak through said main pipe or connect a service pipe to said main pipe, comprising:
a band adapted to wrap around a portion of said main pipe to selectively block a leak in said main pipe portion or connect a service pipe to said main pipe portion; and
a securement device including
a handle pivotably connected to one of said band opposite sides;
a puller pivotably connected to the other of said band opposite sides and extending over said one band opposite side;
a link pivotably connected on one end to said puller and on the other end to said handle,
wherein pivoting said handle toward said band increases the distance between the handle connection to said one band opposite side and the link connection to the puller.

17. The main pipe enclosure of claim 16, wherein said band opposite sides are pulled toward one another by said securement device to tension said band around the main pipe.
